(19) United States
(12) Patent Application Publication
(10) Pub. No.: US 2026/0093131 A1
(43) Pub. Date: Apr. 2, 2026

(54) OPTICAL WAVEGUIDE ELEMENT, AND OPTICAL MODULATION DEVICE AND OPTICAL TRANSMISSION DEVICE USING SAME

(71) Applicant: SUMITOMO OSAKA CEMENT CO., LTD., Tokyo (JP)

(72) Inventors: Yuji HAYAMI, Tokyo (JP); Kosuke OKAHASHI, Tokyo (JP); Yuki KUGIMOTO, Tokyo (JP)

(73) Assignee: SUMITOMO OSAKA CEMENT CO., LTD., Tokyo (JP)

(21) Appl. No.: 19/274,668

(22) Filed: Jul. 21, 2025

(30) Foreign Application Priority Data
Sep. 30, 2024 (JP) 2024-170391

(51) Int. Cl. G02F 1/01; G02F 1/21

(52) U.S. Cl. CPC G02F 1/0147; G02F 1/0113; G02F 1/0121; G02F 1/212; G02F 2201/063; G02F 2201/128

(57) ABSTRACT

An optical waveguide element includes: a substrate having a pyroelectric effect, a protrusion part formed on a surface of the substrate and extending in a specific direction, and an electrode covering at least a portion of the protrusion part. On each of two side surfaces of the protrusion part, charges generated by the pyroelectric effect are mutually opposite charges of positive and negative, and the electrode is arranged to cover the two side surfaces of the protrusion part in each electrically connected region.

### CROSS-REFERENCE TO RELATED APPLICATION

This application claims the priority benefits of Japanese application no. 2024-170391, filed on Sep. 30, 2024. The entirety of the above-described patent application is hereby incorporated by reference herein and made a part of this specification.

### BACKGROUND

### Technical Field

The disclosure relates to an optical waveguide element, an optical modulation device using the same, and an optical transmission device, and particularly relates to an optical waveguide element having a substrate with a pyroelectric effect, a protrusion part formed on a surface of the substrate and extending in a specific direction, and an electrode covering at least a portion of the protrusion part.

### Related Art

In the fields of optical measurement technology and optical communication technology, optical waveguide elements such as optical modulators using ferroelectrics such as lithium niobate (LN) as substrates are widely used. In substrates using ferroelectrics, the polarization of the dielectric changes due to temperature changes, and the charge distribution generated on the substrate surface changes, which is a so-called pyroelectric effect.

On the other hand, in optical waveguide elements, due to drive voltage reduction and miniaturization, the optical waveguide formed on the ferroelectric substrate is made into a rib-type optical waveguide, and the height and width of the cross-section of the rib-type optical waveguide are reduced to, for example, 1 μm or less. Moreover, in order to increase the strength of the electric field applied to the optical waveguide, the spacing between electrodes is also configured to be as narrow as several micro meters. As an example, Patent Document 1 shows an X-cut type LN substrate provided on a rib-type optical waveguide.

For example, in the case of forming a rib-type optical waveguide on the surface of an X-cut type LN substrate, as shown in FIG. 1, a protrusion part P1 forming a rib-type optical waveguide OW and two protrusion parts P2 sandwiching the optical waveguide are formed. Then, charges caused by the pyroelectric effect are generated on the side surfaces of the protrusion parts P1 and P2 according to the direction in which the optical waveguide OW extends. FIG. 1 shows a state where positive charges (+EC) are generated on the side surface on the right side of the protrusion part shown in the drawing, and negative charges (−EC) are generated on the side surface on the left side. In the X-cut type LN substrate, the side surfaces of the protrusion part become the Z-plane.

Moreover, in optical waveguide elements using X-cut type LN substrates, in the action part that applies an electric field to the rib-type optical waveguide, in order to effectively change the refractive index of the optical waveguide with respect to the applied electric field, this Z-plane is usually arranged on the side surfaces of the optical waveguide.

In FIG. 1, the positive and negative charges generated in the protrusion parts (P1, P2) are clearly shown for convenience, but the sign of the charges generated on the side surfaces of the protrusion parts will appear differently in the case of rising temperature change and in the case of falling temperature change.

Since the electrode EL that applies an electric field to the optical waveguide OW is arranged close to the rib-type optical waveguide OW, a part of the electrode EL is arranged to cover one side surface of a protrusion part P2. As described above, the spacing between the electrodes EL sandwiching the optical waveguide becomes narrower due to drive voltage reduction and miniaturization of the optical waveguide element. Therefore, due to temperature changes during the manufacturing process or operation of the optical waveguide element, the charges on the side surfaces of the protrusion part P2 generated by the pyroelectric effect appear on the surface of the electrode EL covering the side surface, and a discharge phenomenon ED is caused between the electrodes EL covering side surfaces with different surface charges, as shown in FIG. 1.

The instantaneous large current that is the discharge phenomenon ED destroys the optical waveguide between the electrodes. Even in the case of not reaching the discharge phenomenon, since the electric field strength between the electrodes increases, local polarization reversal may be formed in the ferroelectric constituting the optical waveguide.

### CITATION LIST

### Patent Document

[Patent Document 1] Japanese Patent Application Laid-Open Publication No. 2022-142650

The problem to be solved by the disclosure is to solve the above-described problems and provide an optical waveguide element that suppresses discharge and the like between electrodes sandwiching an optical waveguide. Moreover, the disclosure provides an optical modulation device and an optical transmission device using the optical waveguide element.

### SUMMARY

An optical waveguide element includes a substrate having a pyroelectric effect, a protrusion part formed on a surface of the substrate and extending in a specific direction, and an electrode covering at least a portion of the protrusion part. On each of two side surfaces of the protrusion part, charges generated by the pyroelectric effect are mutually opposite charges of positive and negative, and the electrode is arranged to cover the two side surfaces of the protrusion part in each electrically connected region.

An optical modulation device is characterized in that the optical waveguide element is housed in a casing and the optical modulation device includes an optical fiber that inputs or outputs light waves with respect to the optical waveguide.

An optical transmission device includes the optical modulation device, and an electronic circuit that outputs a modulation signal for causing the optical modulation device to perform a modulation operation.

### BRIEF DESCRIPTION OF THE DRAWINGS

FIG. 1 is a cross-sectional view showing a conventional optical waveguide element.

FIG. 2 is a cross-sectional view showing a first embodiment of the optical waveguide element according to the disclosure.

FIG. 3 is a plan view showing a second embodiment of the optical waveguide element according to the disclosure.

FIG. 4 is a cross-sectional view taken along chain line A-A′ in FIG. 3.

FIG. 5 is a plan view showing a third embodiment of the optical waveguide element according to the disclosure.

FIG. 6 is a cross-sectional view taken along chain line A-A′ in FIG. 5.

FIG. 7 is a cross-sectional view showing a fourth embodiment of the optical waveguide element according to the disclosure.

FIG. 8 is a cross-sectional view showing a fifth embodiment (part 1) of the optical waveguide element according to the disclosure.

FIG. 9 is a cross-sectional view showing a fifth embodiment (part 2) of the optical waveguide element according to the disclosure.

FIG. 10 is a plan view showing a sixth embodiment of the optical waveguide element according to the disclosure.

FIG. 11A and FIG. 11B are cross-sectional views taken along chain line A-A′ and B-B′ in FIG. 10.

FIG. 12 is a plan view showing a seventh embodiment of the optical waveguide element according to the disclosure.

FIG. 13 is a cross-sectional view showing an eighth embodiment of the optical waveguide element according to the disclosure.

FIG. 14 is a plan view describing the optical modulation device and optical transmission device according to the disclosure.

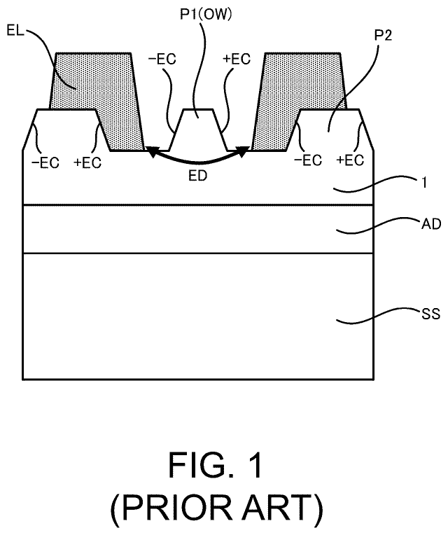

### DESCRIPTION OF THE EMBODIMENTS

An optical waveguide element of the disclosure, and an optical modulation device and an optical transmission device using the same have the following technical features.

(1) An optical waveguide element includes a substrate having a pyroelectric effect, a protrusion part formed on a surface of the substrate and extending in a specific direction, and an electrode covering at least a portion of the protrusion part. On each of two side surfaces of the protrusion part, charges generated by the pyroelectric effect are mutually opposite charges of positive and negative, and the electrode is arranged to cover the two side surfaces of the protrusion part in each electrically connected region.

(2) In the optical waveguide element according to (1) above, a plurality of protrusion parts are formed on the substrate, in which part of the protrusion parts are optical waveguides, and the electrode is an electrode for applying an electric field to the optical waveguide.

(3) In the optical waveguide element according to (1) above, the electrode includes a lower electrode arranged in contact with the surface of the substrate, and an upper electrode arranged on an upper side of the lower electrode, and each lower electrode is arranged to cover the two side surfaces of the protrusion part.

(4) In the optical waveguide element according to (1) above, a conductive membrane having a resistivity of 10⁶ to 10¹¹ Ωm is arranged to cover an upper surface side of the substrate including between the substrate and the electrode, or to cover the upper surface side of the substrate including an upper side of the electrode.

(5) In the optical waveguide element according to (1) above, the electrode, in each electrically connected region, has a ratio between an area covering one side surface of the protrusion part and an area covering the other side surface within a range of 0.8 to 1.2.

(6) In the optical waveguide element according to (1) above, an angle of the side surface of the protrusion part with respect to a plane parallel to the surface of the substrate is smaller than 75 degrees.

(7) In the optical waveguide element according to (1) above, the substrate has a plurality of protrusion parts formed thereon, and there are protrusion parts where a spacing between adjacent protrusion parts is in a range of 1 to 20 μm, and the electrode is arranged on at least one of the adjacent protrusion parts.

(8) In the optical waveguide element according to (1) above, a thickness of an electrode arranged on the side surface of the protrusion part is thinner than a thickness of an electrode arranged on a top part of the protrusion part.

(9) An optical modulation device is characterized in that the optical waveguide element according to (2) above is housed in a casing and the optical modulation device includes an optical fiber that inputs or outputs light waves with respect to the optical waveguide.

(10) In the optical modulation device according to (9) above, the optical waveguide element includes a modulation electrode for modulating light waves propagating through the optical waveguide, and the optical modulation device includes inside the casing an electronic circuit that amplifies a modulation signal input to the modulation electrode of the optical waveguide element.

(11) An optical transmission device includes the optical modulation device according to (9) above, and an electronic circuit that outputs a modulation signal for causing the optical modulation device to perform a modulation operation.

The disclosure relates to an optical waveguide element having a substrate with pyroelectric effect, a protrusion part formed on a surface of the substrate and extending in a specific direction, and an electrode covering at least a portion of the protrusion part, in which charges generated by the pyroelectric effect on each of two side surfaces of the protrusion part are mutually opposite charges of positive and negative, and the electrode is arranged to cover the two side surfaces of the protrusion part in each electrically connected region, thereby making it possible to neutralize charges generated on the side surfaces of the protrusion part and suppress discharge phenomena occurring between electrodes.

Furthermore, it also becomes possible to provide optical modulation devices and optical transmission devices that utilize optical waveguide elements with suppressed discharge phenomena.

Hereinafter, the optical waveguide element of the disclosure will be described in detail using preferred examples.

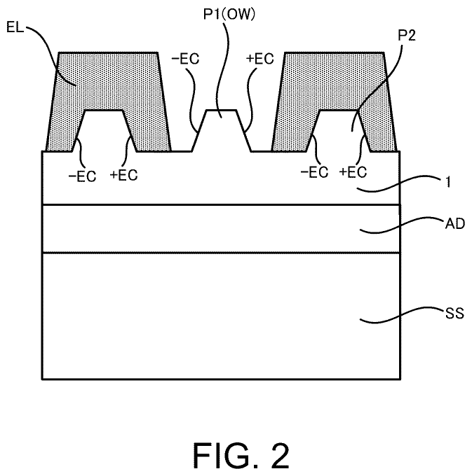

As shown in FIG. 2, the disclosure relates to an optical waveguide element having a substrate 1 having a pyroelectric effect, a protrusion part P2ormed on a surface of the substrate and extending in a specific direction f, and an electrode EL covering at least a portion of the protrusion part, in which charges generated by the pyroelectric effect on each of two side surfaces of the protrusion part P2 are mutually opposite charges of positive and negative (+EC, −EC), and the electrode EL is arranged to cover the two side surfaces of the protrusion part P2 in each electrically connected region.

The material of the substrate 1 having a pyroelectric effect used in the optical waveguide element of the disclosure is a ferroelectric substrate, and specifically, substrates such as lithium niobate (LN), lithium tantalate (LT), PLZT (lead lanthanum zirconate titanate), or base materials obtained by doping these substrate materials with magnesium may be used. In addition, vapor-phase growth membranes made of these materials may also be used. FIG. 2 shows an example of an X-cut type LN substrate, and the side surfaces of the protrusion part P2 are Z-planes.

On the surface of the substrate 1 having a pyroelectric effect, a protrusion part P1 is formed as an optical waveguide, constituting a rib-type optical waveguide OW. In order to apply an electric field based on a modulation signal or DC bias to the optical waveguide OW, an electrode EL is formed to sandwich the rib-type optical waveguide OW. To achieve velocity matching between the microwave of the modulation signal and the light wave, the thickness of the substrate 1 forming the optical waveguide may be set to 10 μm or less, more preferably 5 μm or less, and even more preferably 1 μm or less. Such a thin substrate 1 may have a holding substrate SS adhesively fixed to the lower side of the substrate 1 through direct bonding or through a bonding layer AD such as resin to enhance mechanical strength. As the holding substrate SS for direct bonding, a substrate having a lower refractive index than the optical waveguide or than the substrate on which the optical waveguide is formed and including a material having a thermal expansion coefficient close to that of the optical waveguide, such as an oxide layer of alkali-free glass or quartz, is preferably used. Composite substrates abbreviated as SOI or LNOI, in which a silicon oxide layer is formed on a silicon substrate, or composite substrates in which a silicon oxide layer is formed on an LN substrate, may also be used. In the case of using such composite substrates, the bonding layer AD may be omitted.

As a method for forming the optical waveguide OW, as shown in FIG. 2, it is possible to utilize a rib-type optical waveguide in which a portion corresponding to the optical waveguide is formed as a protrusion part on the substrate by etching the substrate 1 or forming grooves on both sides of the optical waveguide. In the case of using the above-described thin substrate, the height of the rib-type optical waveguide is set to 4 μm or less, more preferably 3 μm or less, and even more preferably 1 μm or less or 0.4 μm or less. The width of the rib-type optical waveguide OW is also set to, for example, 1 μm or less, similar to the height. It is also possible to form a vapor-phase growth membrane on the holding substrate SS and process the membrane into the shape of an optical waveguide.

In the optical waveguide element to which the disclosure is applied, as shown in FIG. 2, in the case of forming a protrusion part P2 extending in a specific direction on the substrate 1 having a pyroelectric effect, charges generated by the pyroelectric effect may occur on two side surfaces of the protrusion part P2 as mutually opposite charges of positive and negative (+EC, −EC). Specifically, in the case of using an X-cut type LN substrate, in the case that the formation direction of the protrusion part is selected such that the side surfaces of the protrusion part P2 become Z-planes, opposite charges of positive and negative are generated on the two side surfaces of the protrusion part P2 by the pyroelectric effect.

In the disclosure, electrodes are arranged to cover the side surfaces of the protrusion part that generate different charges of positive and negative, such that shape of the electrode is formed to electrically connect the electrodes arranged on different side surfaces, thereby generating an effect in the electrode EL that cancels out (offsets) the charges generated on the side surfaces of the protrusion part. In this way, the region where one electrode EL is formed is set to necessarily include each side surface where different charges of the protrusion part are generated.

As a result, the electrodes EL on both sides of the rib-type optical waveguide OW do not carry either positive or negative charges even in the case of occurrence of the pyroelectric effect, and no potential difference is generated between the electrodes EL, so the optical waveguide is not destroyed by discharge phenomenon or the like.

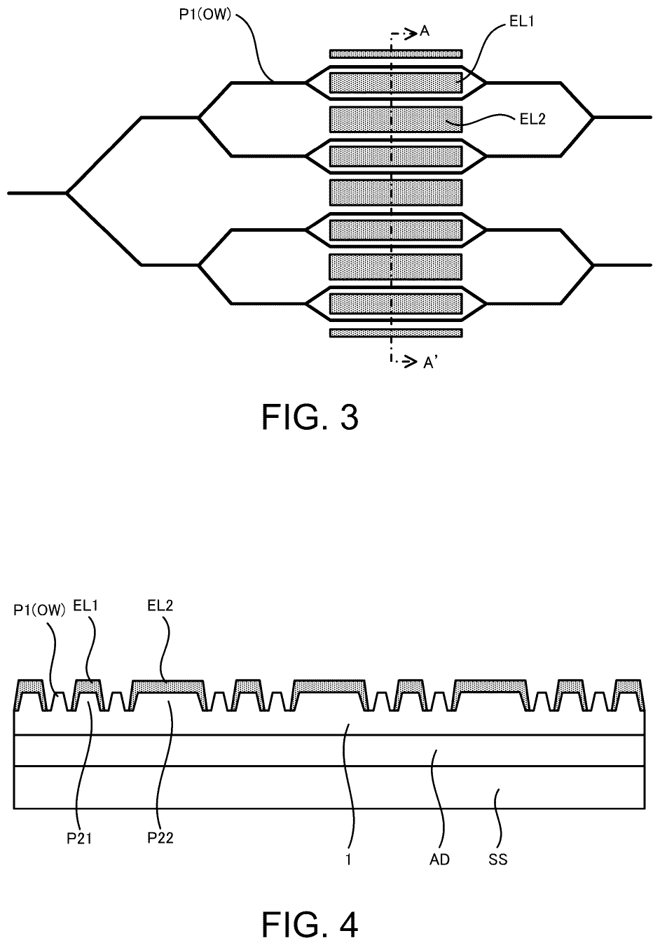

FIG. 3 is a plan view showing an example of an optical waveguide element using an optical waveguide in which a plurality of Mach-Zehnder optical waveguides are arranged in a nested manner as the rib-type optical waveguide OW. FIG. 4 shows a cross-sectional view along chain line A-A′ in FIG. 3. On the surface of the substrate 1, a protrusion part P1 constituting the optical waveguide OW is formed, and protrusion parts P21 and P22 are formed to sandwich it. In the protrusion parts P21 and P22, similar to FIG. 2, positive and negative charges are generated on two side surfaces of the protrusion parts by the pyroelectric effect, so electrodes EL1 and EL2 are arranged on all protrusion parts (P21, P22) except for the rib-type optical waveguide OW. Each electrode EL1 or EL2 is configured to cover both side surfaces that generate different charges of the protrusion part (the side surface that generates positive charge (+EC) and the side surface that generates negative charge (−EC) in FIG. 2).

By having electrodes (EL1 and EL2) with suppressed charging adjacent to each other, the potential difference between the adjacent electrodes becomes small, and as a result, discharge breakdown can be suppressed. As shown in FIG. 3 and FIG. 4, in the case of forming a plurality of protrusion parts on the substrate 1, many protrusion parts exist where the spacing between adjacent protrusion parts is in the range of 1 to 20 μm, making discharge breakdown likely to occur. Therefore, by arranging electrodes that cover both side surfaces of the protrusion part on at least one of the adjacent protrusion parts, it becomes possible to suppress discharge breakdown.

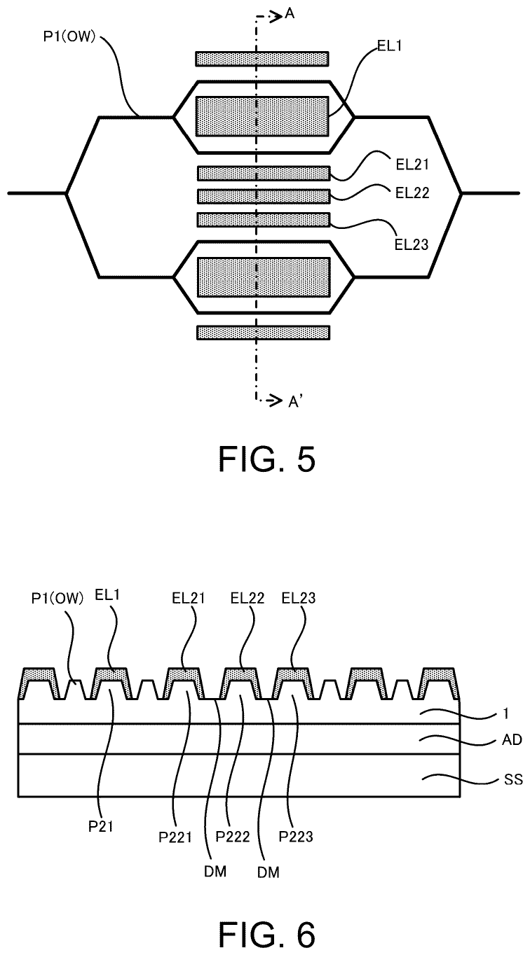

FIG. 5 shows electrode arrangement in the case of applying a differential signal to one Mach-Zehnder optical waveguide. Specifically, in the case of using a positive electrode that applies a positive electrical signal as electrode EL1, the electrode (EL21) that sandwiches the optical waveguide OW together with the positive electrode EL1 becomes a negative electrode that applies a negative electrical signal. The electrode sandwiched between two Mach-Zehnder optical waveguides is divided into three electrodes, constituting a negative electrode EL21, a ground electrode EL22, and a negative electrode EL23. As an example of electrode arrangement that sandwiches two branched waveguides (OW) of one Mach-Zehnder optical waveguide, the arrangement is in the order of ground electrode—negative electrode—branched waveguide OW—positive electrode—branched waveguide OW—negative electrode—ground electrode.

Normally, since the electrode EL2 in FIG. 3 is simply divided into three, a configuration that only subdivides the electrode into three would be sufficient. However, in the case of dividing the electrode EL2 in FIG. 4 into three parts, the electrodes at both ends are hung on one side surface of a protrusion part P22, and the central electrode would be arranged only on the upper surface of the protrusion part P22. In such a case, a potential difference occurs between the electrodes arranged on both sides of the protrusion part P22, which may lead to discharge breakdown.

In the optical waveguide element of the disclosure, in the case of applying such a differential signal, as shown in FIG. 6, by adding a dummy groove DM between adjacent Mach-Zehnder optical waveguides and forming electrodes in each of the three divided electrodes (EL21 to 23) so as to cover both side surfaces of the protrusion parts (P221 to P223), it becomes possible to suppress discharge breakdown.

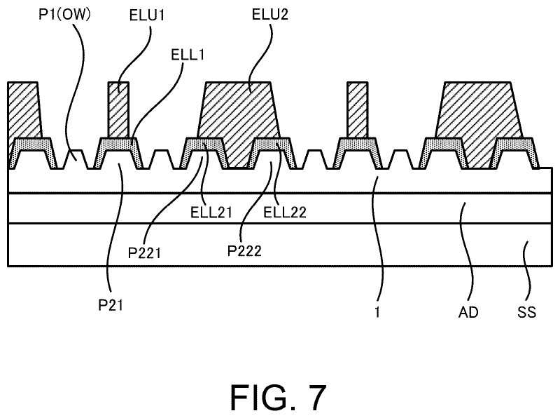

The optical waveguide element shown in FIG. 7 shows an example in the case of configuring electrodes in multiple stages, such as thin electrodes (ELL1, etc.) and thick electrodes (ELU1, etc.). The intention of configuring electrodes in multiple stages in this way is that in order to efficiently generate an electric field in accordance with the height of the optical waveguide, etc., a thin electrode close to the height of the optical waveguide is arranged with respect to the electrode close to the optical waveguide. Moreover, in electrodes that propagate microwaves such as modulation signals, thick electrodes are formed on the thin electrodes in order to achieve matching between the effective refractive index of light and the refractive index of microwaves (Nm), and also to reduce the waveguide loss of the electrodes.

Since the thin electrodes (ELL1, etc.) and thick electrodes (ELU1, etc.) are electrically connected to each other, it is also possible to configure, for example, the thin electrode to cover the side surface of the positive charge of the protrusion part and the thick electrode to cover the side surface of the negative charge of the protrusion part. However, in FIG. 7, first, the thin electrodes (ELL1, ELL21, ELL22) are configured to cover the two side surfaces of the protrusion part, and are configured such that the potential difference between the thin electrodes does not become large. This is to suppress the occurrence of discharge breakdown, etc. between the thin electrodes due to the substrate temperature changing between after forming the thin electrodes and before forming the thick electrodes, causing the pyroelectric effect to occur.

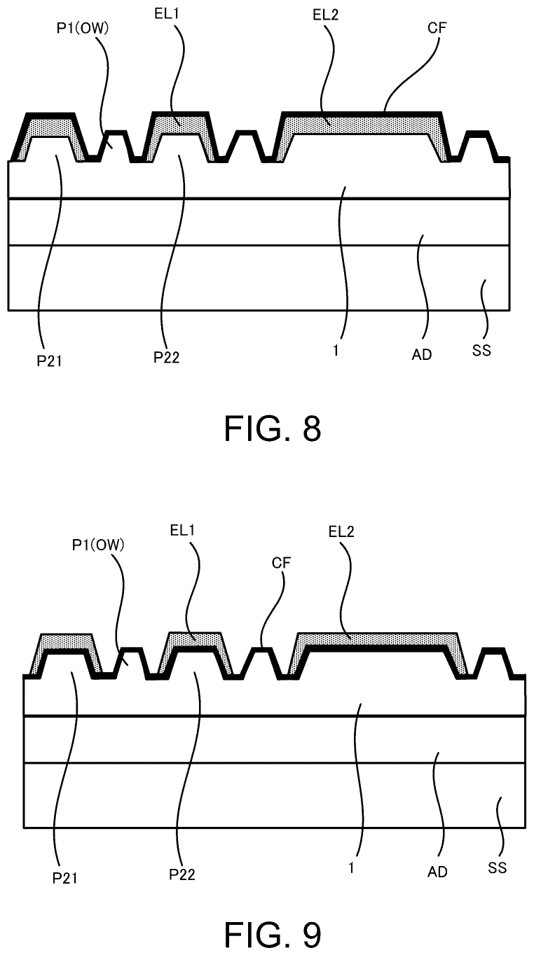

FIG. 8 and FIG. 9 show formations of a membrane body CF having slight conductivity on the substrate 1 or on the electrodes (EL1 to 2) in order to make the potential difference generated between each electrode smaller. Specifically, an electric field corresponding to the modulation signal and DC bias is formed between each electrode and applied to the optical waveguide. For this reason, it is not possible to form a conductive membrane that connects between the electrodes, but in order to alleviate even slightly the potential difference generated by the pyroelectric effect, a membrane body having slight conductivity with an electrical resistivity of 10⁶ to 10¹¹ Ωm is formed. As the membrane body CF, membrane bodies such as Si or SiN may be used. By forming this membrane body having slight conductivity, even in the case of a potential difference being generated between electrodes, it becomes possible to suppress discharge breakdown by gradually discharging.

As for the formation location of the membrane body CF, in FIG. 8, since the membrane body CF is arranged after forming the electrodes, the membrane body CF is arranged so as to cover the upper surface side of the substrate 1, including the upper side of the electrodes. That is, after forming the protrusion parts (P1, P21, and P22) such as optical waveguides on the substrate 1, the electrodes (EL1, EL2) are formed, and then the membrane body CF is formed on the entire upper surface side of the substrate 1. Naturally, it is also possible to partially form the membrane body such that each electrode is connected, including the protrusion parts where electrodes are not formed.

On the other hand, in FIG. 9, after forming the protrusion parts (P1, P21, and P22) on the substrate 1, the membrane body CF is arranged on the entire upper surface of the substrate 1 before forming the electrodes. Then, after that, the electrodes (EL1, EL2) are formed. For this reason, the membrane body CF is arranged so as to cover the upper surface side of the substrate 1, including between the substrate 1 and the electrodes. Regarding the membrane body CF in FIG. 9 as well, instead of forming it on the entire upper surface of the substrate 1, it is also possible to partially arrange the membrane body CF so as to connect each electrode, including at least the protrusion parts where electrodes are not formed.

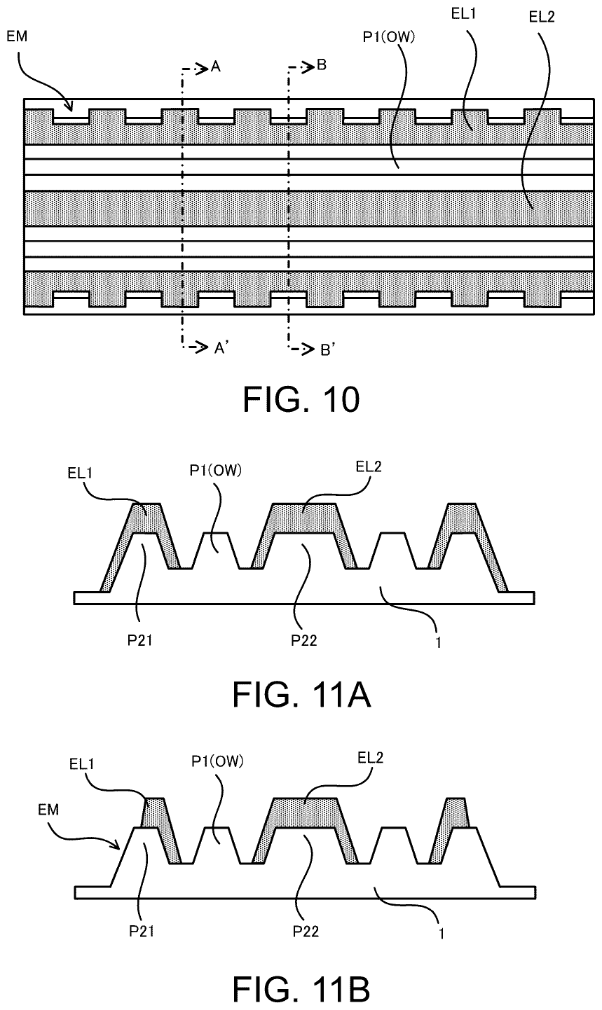

FIG. 10, FIG. 11A, and FIG. 11B describe correspondence in the case of the areas of the side surfaces on both sides of the protrusion part being different. FIG. 10 is a plan view of the optical waveguide element, and FIG. 11A and FIG. 11B are cross-sectional views along chain lines A-A′ and B-B′ in FIG. 10. FIG. 11A corresponds to chain line A-A′, and FIG. 11B corresponds to chain line B-B′.

Referring to FIG. 11A and FIG. 11B, in the protrusion part P22, the lengths (areas) of the side surfaces on both sides of the protrusion part are the same, but in a protrusion part P21 (left end of the drawing), the length (area) of the side surface on the left side of the protrusion part is larger than the length (area) of the side surface on the right side. The protrusion parts located at both ends of FIG. 11A and FIG. 11B have different lengths (areas) of the side surfaces on both sides. The fact that the lengths (areas) of the side surfaces on both sides of the protrusion part are different may also be expressed as the depths of the grooves on both sides of the protrusion part being different.

For this reason, regarding the electrode EL1 that covers the protrusion part P21, as shown in FIG. 10, FIG. 11A, and FIG. 11B, for the electrode on the side where the length (area) of the side surface of the protrusion part is longer (larger), a portion EM not covered by the electrode is partially provided. It is preferable to set the area of the side surface of the protrusion part covered by one electrode EL1 to be approximately the same for each different side surface of the protrusion part. This makes it possible for one electrode to cancel out (offset) the positive and negative charges generated by the pyroelectric effect with each other.

Focusing on the formation region of one electrode that partially covers the protrusion part, it is preferable that the ratio between the area covering one side surface of the protrusion part (for example, the side surface that generates positive charge +EC) and the area covering the other side surface (for example, the side surface that generates negative charge −EC) be equal. However, in the case of the ratio being within the range of 0.8 to 1.2, it becomes possible to suppress the charge accumulated in the electrode to some extent, and it is possible to suppress discharge breakdown.

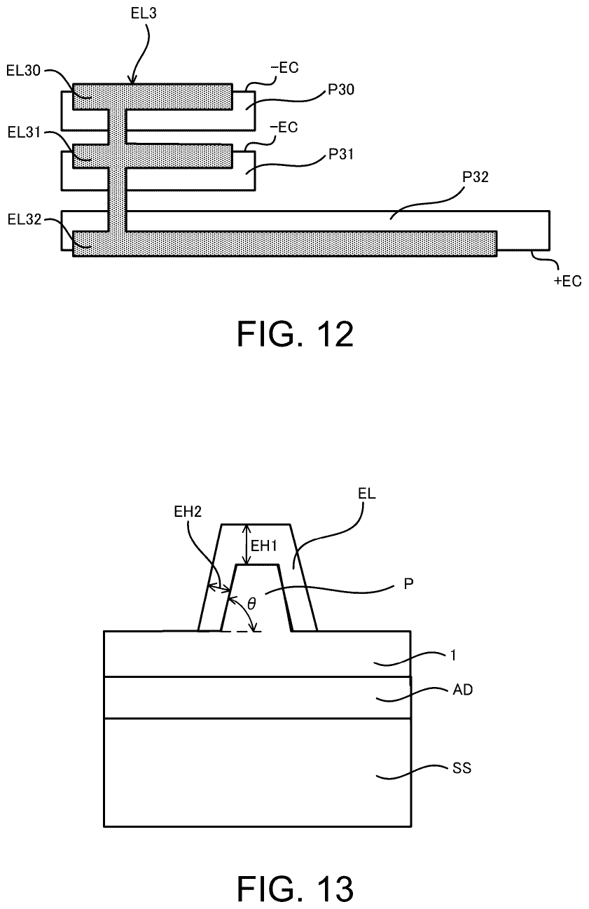

FIG. 12 shows a state where the region of one electrode EL3 is formed spanning a plurality of protrusion parts (P30 to P32). Even in such a case, it is preferable to set the total sum of the area where the electrode (for example, EL32) covers the side surface of the protrusion part where positive charge (+EC) is formed and the total sum of the area where the electrode (for example, EL30, EL31) covers the side surface of the protrusion part where negative charge (−EC) is formed to be approximately the same, and to configure such that the positive and negative charges are offset as a whole. Even in this case, by setting the ratio between the area where the electrode covers the side surface of positive charge and the area where the electrode covers the side surface of negative charge within the range of 0.8 to 1.2, it becomes possible to suppress discharge breakdown to some extent. In this way, by arranging one electrode spanning a plurality of protrusion parts, charging due to the pyroelectric effect can be canceled in a limited space, and design flexibility can also be secured.

FIG. 13 shows an electrode EL that covers one protrusion part P. It is preferable that a thickness EH2 of the electrode arranged on the side surface of the protrusion part P be thinner than a thickness EH1 of the electrode arranged on the top part of the protrusion part P. For example, in the case of an X-cut type LN substrate, the side surface of the protrusion part P becomes the Z-plane, and the Z-plane receives stress due to the linear expansion coefficient difference of the material and is prone to charging upon receiving stress. To prevent this charging, it is preferable that the electrode thickness on the Z-plane be thinner than the electrode arranged on the X-plane (top part of the protrusion part). More specifically, the thickness EH1 of the electrode on the top part of the protrusion part is set to 200 nm or more, and the thickness EH2 of the electrode on the side surface of the protrusion part is set to EH1×0.8 or less.

For example, the linear expansion coefficients in the X and Y directions of the Z-plane in the LN substrate are both 1.5×10⁻⁵ (/K), and the linear expansion coefficients in the Y and Z directions of the X-plane are 1.5×10⁻⁵ (/K) in the Y direction and 0.75×10⁻⁵ (/K) in the Z direction. Moreover, the linear expansion coefficient of the electrode material (Au) is 1.4×10⁻⁵ (/K).

The stress at the interface between dissimilar materials becomes the product of the linear expansion coefficient difference between the two materials and the length of a contact surface. Since the length in the Z direction (left-right direction in the drawing) is sufficiently small relative to the length in the Y direction (direction perpendicular to the drawing in FIG. 13), the stress due to the difference between the linear expansion coefficient in the Z direction and the linear expansion coefficient of the electrode is extremely small. If the electrode thicknesses on the Z-plane and X-plane are the same, it may be said that the stresses due to the linear expansion coefficient differences of the Z-plane and X-plane respectively are approximately equal. However, since the Z-plane has a property of being more prone to charging due to stress compared to the X-plane, by forming the electrode thickness on the Z-plane thinner than that on the X-plane, it becomes possible to relieve stress and suppress charging.

To reliably form an electrode on the side surface of the protrusion part and to form the thickness of the electrode on the side surface of the protrusion part thinner than the electrode on the top part of the protrusion part, it is preferable that an angle θ of the side surface of the protrusion part P with respect to a plane parallel to the surface of the substrate 1 in FIG. 13 be smaller than 75 degrees. Moreover, it is preferable that the angle θ be larger than 45 degrees. This is because, in the disclosure, to more prominently manifest the effect of the configuration that covers both side surfaces (Z-planes) of the protrusion part in FIG. 13 with electrodes, it is considered preferable to have a side surface angle where the Z-plane component of the protrusion part side surface becomes larger than the X-plane component. Since the influence of the Z-plane (proneness to charging) on the side surface of the protrusion part decreases as the side surface angle θ becomes smaller, it is preferable to set the angle θ larger than 45 degrees such that more influence of the Z-plane remains.

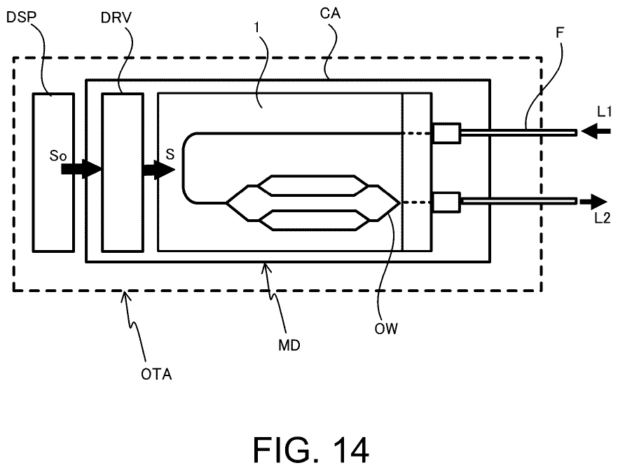

Next, an example in which the optical waveguide element of the disclosure is applied to an optical modulation device or an optical transmission device will be described. FIG. 14 describes an optical modulation device that incorporates an optical waveguide element using a nested optical waveguide, but the disclosure is not limited thereto and is also applicable to optical phase modulators, optical modulators having a polarization combining function, optical waveguide elements integrating more Mach-Zehnder optical waveguides, bonding devices with optical waveguide elements composed of other materials such as silicon, devices for sensor applications, and the like. Furthermore, it goes without saying that the disclosure is applicable to High Bandwidth-Coherent Driver Modulators (HB-CDM).

As shown in FIG. 14, the optical waveguide element includes an optical waveguide OW formed on the substrate 1 and modulation electrodes (not shown) that modulate light waves propagating through the optical waveguide, and is housed in a casing CA. Furthermore, by providing an optical fiber (F) that inputs and outputs light waves to and from the optical waveguide, an optical modulation device MD may be configured. An optical fiber F is optically coupled to the optical waveguide OW inside the optical waveguide element using an optical block equipped with an optical lens, or a lens barrel, and the like. Not limited thereto, the optical fiber may be introduced into the casing through a through-hole that penetrates the side wall of the casing, and the optical component or substrate and the optical fiber may be directly bonded, or an optical fiber having a lens function at the optical fiber end may be optically coupled to the optical waveguide inside the optical waveguide element. L1 indicates incident light, and L2 indicates outgoing light.

An optical transmission device OTA may be configured by connecting an electronic circuit (digital signal processor DSP) that outputs a modulation signal So for causing the optical modulation device MD to perform a modulation operation to the optical modulation device MD. In order to obtain a modulation signal S to be applied to the optical waveguide element, it is necessary to amplify the modulation signal So output from the digital signal processor DSP. Therefore, in FIG. 14, a driver circuit DRV is used to amplify the modulation signal. The driver circuit DRV and the digital signal processor DSP may be arranged outside the casing CA, but may also be arranged inside the casing CA. In particular, by disposing the driver circuit DRV inside the casing, it becomes possible to further reduce propagation loss of the modulation signal from the driver circuit.

### INDUSTRIAL APPLICABILITY

As described above, according to the disclosure, it becomes possible to provide an optical waveguide element that suppresses discharge and the like between electrodes sandwiching an optical waveguide. Furthermore, it becomes possible to provide an optical modulation device and an optical transmission device using the optical waveguide element.

What is claimed is:

1. An optical waveguide element, comprising: a substrate having a pyroelectric effect, a protrusion part formed on a surface of the substrate and extending in a specific direction, and an electrode covering at least a portion of the protrusion part,
wherein on each of two side surfaces of the protrusion part, charges generated by the pyroelectric effect are mutually opposite charges of positive and negative, and
the electrode is arranged to cover the two side surfaces of the protrusion part in each electrically connected region.

2. The optical waveguide element according to claim 1,
wherein a plurality of protrusion parts are formed on the substrate, in which part of the protrusion parts are optical waveguides, and
the electrode is an electrode for applying an electric field to the optical waveguide.

3. The optical waveguide element according to claim 1,
wherein the electrode comprises a lower electrode arranged in contact with the surface of the substrate, and an upper electrode arranged on an upper side of the lower electrode, and
each lower electrode is arranged to cover the two side surfaces of the protrusion part.

4. The optical waveguide element according to claim 1,
wherein a conductive membrane having a resistivity of 10⁶ to 10¹¹ Ωm is arranged to cover an upper surface side of the substrate including between the substrate and the electrode, or to cover the upper surface side of the substrate including an upper side of the electrode.

5. The optical waveguide element according to claim 1,
wherein the electrode, in each electrically connected region, has a ratio between an area covering one side surface of the protrusion part and an area covering the other side surface within a range of 0.8 to 1.2.

6. The optical waveguide element according to claim 1,
wherein an angle of the side surface of the protrusion part with respect to a plane parallel to the surface of the substrate is smaller than 75 degrees.

7. The optical waveguide element according to claim 1,
wherein the substrate has a plurality of protrusion parts formed thereon, and there are protrusion parts where a spacing between adjacent protrusion parts is in a range of 1 to 20 μm, and
the electrode is arranged on at least one of the adjacent protrusion parts.

8. The optical waveguide element according to claim 1,
wherein a thickness of an electrode arranged on the side surface of the protrusion part is thinner than a thickness of an electrode arranged on a top part of the protrusion part.

9. An optical modulation device,
wherein the optical waveguide element according to claim 2 is housed in a casing, and
the optical modulation device comprises an optical fiber that inputs or outputs light waves with respect to the optical waveguide.

10. The optical modulation device according to claim 9,
wherein the optical waveguide element comprises a modulation electrode for modulating light waves propagating through the optical waveguide, and
the optical modulation device comprises inside the casing an electronic circuit that amplifies a modulation signal input to the modulation electrode of the optical waveguide element.

11. An optical transmission device, comprising:
the optical modulation device according to claim 9, and
an electronic circuit that outputs a modulation signal for causing the optical modulation device to perform a modulation operation.
